(19) United States
(12) Patent Application Publication
(10) Pub. No.: US 2011/0119098 A1
(43) Pub. Date: May 19, 2011

(54) Ticketing System

(75) Inventors: Norbert Miller, Monchengladbach (DE); Matthias Augustyniak, Wegberg (DE)

(73) Assignee: SCHEIDT & BACHMANN GMBH, Monchengladbach (DE)

(21) Appl. No.: 12/946,891

(22) Filed: Nov. 16, 2010

(30) Foreign Application Priority Data
Nov. 16, 2009 (EP) 09 014 273.8
Jan. 25, 2010 (EP) 10 000 711.1

(51) Int. Cl. G06Q 10/00

(52) U.S. Cl. 705/5

(57) ABSTRACT

In order to expand the area of application of a ticketing system that works based on a virtual ticket, a method for operating a ticketing system is proposed, in which a virtual ticket is generated, a user-dependent access code is allocated to the virtual ticket, the virtual ticket is stored together with the access code, the access code is stored in a separate data memory, and the virtual ticket is accessed by entering the access code stored in the separate data memory at an entry point of the ticketing system provided for this purpose.

### BACKGROUND OF THE INVENTION

The invention relates to a method for operating a ticketing system.

Ticketing systems, also referred to as tally card systems, are known as such from prior art, as are methods for their operation.

Use is currently being made in particular of those ticketing systems that work based on actually existing tickets, such as magnetic cards or the like. However, ticketing systems have also become known that work based on virtual tickets. In such systems, a ticket is no longer comprised of a medium to be kept on the person of the user. Rather, the ticket is present as a virtual ticket in the form of a data record, which is stored in a memory of the ticketing system, the so-called back office. The virtual ticket is here allocated to the user via personal data of the user, which are stored together with the virtual ticket in the back office of the ticketing system. The virtual ticket is accessed in such a way that the personal data are used as the search criterion and key.

Ticketing systems with virtual tickets are currently used in particular by airlines for purposes of aircraft access control, i.e., boarding.

The previously known ticketing systems that work based on virtual tickets are disadvantageously not suitable for anonymous users. The virtual tickets are accessed via personal data known to the ticketing system, which precludes anonymization. As a result, the use of previously known ticketing systems is confined to only very special areas of application.

The object of the invention is to expand the area of application of ticketing systems that work based on virtual tickets.

### SUMMARY OF THE INVENTION

To achieve this object, the invention proposes a method for operating a ticketing system in which
a virtual ticket is generated,
a user-independent access code is allocated to the virtual ticket,
the virtual ticket is stored together with the access code,
the access code is stored in a separate data memory of the user,
   and in which the virtual ticket is accessed by entering the access code stored in the separate data memory at an entry point of the ticketing system provided for this purpose.

The method according to the invention advantageously permits operation of a ticketing system that works based on virtual tickets for anonymous users as well. As opposed to the systems previously known from prior art, the application, meaning use, of personal data is not required. As a result, the method according to the invention can also be used in those areas that do not provide for the acquisition of personal data, for example as opposed to aircraft access control. Examples here include tickets for local public transportation in the form of day or month tickets.

Operation according to the invention takes place as follows. A user acquires a ticket in the form of a virtual ticket, i.e., in the form of a data record. This data record contains all ticket information, which for example in the case of a ticket for local public transportation can encompass the fare zone, time of day, period of validity, any restrictions on use and/or the like. An access code is allocated to the virtual ticket, specifically a user-independent access code. For example, the latter can be a simple numerical and/or alphabetic sequence.

The access code is stored along with the virtual ticket in the back office of the ticketing system. Sine the access code is a one-to-one code, the latter also permits a one-to-one identification of the allocated virtual ticket.

The access code is further stored in a separate data memory of the user. The data memory can be a memory card, for example in the form of a smart card, a chip card or the like, but also take the form of other storage media, for example a mobile telephone, a mobile computer or the like. However, the memory can also involve a simple printout of the access code on paper.

In order to now be able to access the virtual ticket, the access code must be entered at an entry point of the ticketing system provided for this purpose. This can be done either manually or even automatically by having the entry point wirelessly read out the access code stored in the separate data memory, for example. The access code imparted to the ticketing system via the entry point is now used by the system for the one-to-one identification of the virtual ticket acquired beforehand by the user. The accompanying data record is read out by the system, and results in the generation of a corresponding output signal at the access code entry point, for example which triggers a safety disconnect, enables access and/or concludes a similar validation and/or access control.

The advantage to the implemented method according to the invention lies in the fact that the method is performed—person-independent—by using a one-to-one access code. In this case, the access code can in an alternative embodiment of the invention also contain personal data, such as the electronic fingerprint, in order in particular to handle safety-relevant aspects as needed. However, as opposed to prior art, the method according to the invention permits a basic ticketing system operation without personal data, thereby also enabling an anonymized use, or utilization even by anonymous users.

Another feature of the invention provides that the access code be allocated to the virtual ticket as the virtual ticket is being generated. The time selected to generate the virtual ticket can here be the time at which sold to the user. As an alternative, it is also possible to select the time at which the ticket is produced or pre-produced as this time. In particular, this can relate to tickets for day or month tickets for local public transport, which are sold in the form of smart cards at sales locations outside the system, such as kiosks and magazine stores. It is only essential to the invention that a one-to-one identification of the generated virtual ticket be possible during its subsequent use via the access code allocated to the ticket.

Another feature of the invention provides that the virtual ticket be centrally stored along with the access code. Several central locations can also be provided, if needed. It is only important that it be possible to retrieve the stored virtual ticket and access code providing the one-to-one identification of the virtual ticket, most preferably without giving the user the chance to access and manipulate the data.

The separate data memories that users can carry with them basically include all data memories that can be used to store an access code according to the invention. These are understood first and foremost to be common data memories that users can easily and conveniently take with them. These can be chip cards, magnetic strip cards, smart cards and/or the like. Of course, other storage media, such as mobile telephones, laptops, notebooks, iPods and/or the like are also suitable for this purpose. With respect to the data memory, a distinction can here essentially be made between those that users already have in their possession anyway, and those that the user newly acquires. If the data memory is one already in the possession of the user, the access code is transferred to this data memory. For example, this can be accomplished by means of conventional interfaces, such as Bluetooth. As an alternative, it is also possible to use data memories that the user acquires when purchasing the virtual ticket, and returns when accessing the virtual ticket at the entry point of the ticketing system provided for this purpose. In this conjunction, both one-way memories and reusable data memories can be used.

As an alternative, users themselves can provide the access code in that the access code is read out from a medium or identification of the user. The readout can take place electronically or optically. After read out, the access code is stored together with the virtual ticket, and used to recognize the user in the system. For example, this can be utilized to make usable in the system those identifications having no electronic memory or for which the content in the electronic memory is read-only. The group of media without electronic memory includes personal ID cards or driver's licenses, and the group of media with a read-only memory, such as passports, credit cards with RFID technology, smart cards of foreign providers, etc.

In the embodiment of the method according to the invention described above, the virtual ticket, meaning the data record, is stored in the data memory of a central data processor. If access is made to the virtual ticket at an entry point with a communication link to the central data processor, the access data are transmitted from the entry point to the central data processor. Allocation to the virtual ticket then takes place here, along with a verification of validity. The result of this query performed by the central data processor is transmitted to the correlated entry point in the form of a data record. Based on the result of the verification by the central data processor, this is followed by a notification to the holder of the virtual ticket, for example telling him or her that the virtual ticket is valid, and the action he/she requested can be executed. If the verification proves unsuccessful, an error message can be displayed to the user of the virtual ticket.

An alternative embodiment of the method described above proposes that, when the virtual ticket is accessed for the first time, a copy of the ticket be generated and stored in a data memory of the entry point at which the access took place. In this alternative embodiment of the invention, an inquiry is processed locally, and not centrally. According to the invention, this is accomplished by generating a copy of the centrally stored ticket when access is made for the first time. This copy is sent to the accompanying entry point, and stored in a data memory belonging to the entry point. The ticket copy contains all ticket data necessary for rate (e.g. fare) determination, and enables a purely local processing during subsequent uses. If the virtual ticket is used again at this entry point, the latter can be processed based on the ticket copy present in the data memory of the entry point, thereby eliminating the need to access the original managed by the central data processor. This advantageously cuts communication and computing time and capacity, yielding a speed advantage. In an alternative embodiment of the method described above, the method can be modified to have the access code that is allocated to the virtual ticket be a user-dependent access code. For example, this type of user-dependent access code can take the shape of identification numbers, codes or the like of credit cards, debit cards in general, identification cards, such as personal ID cards and/or the like. In particular, the advantage to using a user-dependent access code is that users of the virtual ticket can have recourse to identification means already in their possession, which are one-to-one, and can hence be utilized in combination with the application of a virtual ticket according to the invention. An additional organizational outlay can be avoided, in particular the provision of access codes yet to be generated. In sum, the alternative embodiment of the invention hence proposes a method modified from the afore described embodiment, in that it has a user-dependent access code that is allocated to a virtual ticket, of which a copy is generated in the configuration of the alternative embodiment of the invention.

As an alternative, the respective rate can also be determined via the central computer, without copies of the virtual ticket being locally stored.

As a consequence, the method according to the invention in the alternative configuration of the invention also relates to a method for operating a ticketing system, in which
a virtual ticket is generated,
an access code is allocated to the virtual ticket,
the virtual ticket is stored together with the access code,
the access code is stored in a separate data memory,
   and in which the virtual ticket is accessed by entering the access code stored in the separate data memory at an entry point of the ticketing system provided for this purpose, wherein, when the virtual ticket is accessed for the first time, a copy of the ticket is generated and stored in a data memory of the entry point at which the access takes place.

It is especially favorable to implement the method according to the invention in the alternative configuration given the expectation that one and the same virtual ticket will be utilized repeatedly by the user, preferably always via the same entry point. This is especially the case in local public transport, which is used in particular by commuters who take the same route to and from work every day. In this case, the alternative configuration of the invention makes it possible to enormously simplify and reduce the communication required for ticket verification, since multiple transmissions can be avoided. Rather, data processing takes place on site, meaning locally, so that communication with the central data processor can be omitted.

Another advantage to the alternatively configured method is that an intended function is also possible during offline operation, meaning when the communication link between the central data processor and entry point connected thereto is interrupted and/or disrupted. Since access to the central data processor is not required to process a virtual ticket, implementation of the method for the intended purpose can continue even during offline operation.

The locally stored ticket copy can be stored in the local memory for a prescribed period of time, wherein automatic deletion takes place upon expiration of this prescribed period of time. For example, such an automatic deletion can take place a few days or weeks after initial ticket usage, or even after the last ticket usage. For example, if the virtual ticket is a monthly ticket for local public transportation, deletion can take place automatically upon expiration of the period of validity, which can be computed in advance by the central data processor during an initial access. During the distribution of ticket data, the central data processing station can further acquire the validity period of the local copy based on card data, and include it during distribution of the ticket data.

Another embodiment of the invention can provide that, when the virtual ticket is accessed for the first time, a copy of the ticket is stored not just in the data memory of the entry point at which the access takes place, but rather that a ticket copy is made available to several entry points simultaneously. For example, it can be provided that a plurality of entry points belong to a so-called local region. If an initial access is generated via an entry point in this local region, all entry points of the local region are furnished with a copy of the virtual ticket. This configuration of the method ensures that the process is completed quickly, even in cases where the user of a virtual ticket alternates between several entry points of a local region. In this conjunction, it can be provided that each entry point has a separate data memory. Of course, it is alternately possible to provide a shared data memory for the entry points of a local region, for example which is part of a data processing unit. In this case, a type of sub- or secondary network is formed.

Another feature of the invention can provide that data acquired by an entry point are stored and/or transmitted to a central location for storage. This central location can be the data processing unit of a secondary network or the central data processor of the entire ticketing system. The advantage to transmission to the central data processor lies in the fact that corresponding copies of the new data can here automatically generated and relayed to those entry points that already received the original data records. This ensures that all entry points always have the valid data records. This alternative embodiment of the invention is suitable in particular within the framework of so-called pre-paid processes. A user has stored a specific account in the memory of the central data processor. During use, the corresponding amount for the use must be debited from this account. During the implementation of the method as described above, this takes place by transmitting data from the entry point to the central data processor. The new account balance is then centrally computed here, and relayed to one or more entry points of the ticketing system as needed, so that local processing can take place at the corresponding entry points based on up-to-date data records. The corresponding entry points can be stored and/or managed in a distributor list in the central data processor.

The implementation of the method according to the invention can find application in particular in local passenger transport, in which case a virtual ticket is a ticket, for example a day ticket, a weekly ticket and/or a monthly ticket, which when valid entitles someone to use local public transportation, such as buses and/or trains. When such a ticket is used for the first time, the data acquired by the corresponding entry point of the ticketing system are transmitted to the central data processor to identify the virtual ticket. The virtual ticket is then identified here, and a copy of the latter is sent to the data memory of the querying entry point. For example, the sent data can contain information about price stages, duration and zone of validity, as well as hot, white and/or blacklist entries. All of this information is stored locally in the data memory of the entry point, and also checked for validity there. If this validity check is positive, the user is allowed access. Otherwise not.

The data downloaded to the data memory of the local entry point remain in the memory of the entry point for a predetermined period, for example seven days, or until the validity of the virtual ticket has expired, wherein such a memory can also be a component of a local data processing unit, which has a communications link with a plurality of entry points for a local zone.

When the user appears again within the rate period, the authorization of the virtual ticket is checked against the locally stored data, meaning based on the ticket copy generated of the virtual ticket and stored in the data memory of the entry point. Proceeding in this way is expedient and advantageous, since people generally always go the same way to work or recreational facilities, for example, meaning cover the same route in local passenger transport and/or use the same bus and/or train line over and over again. As a result of implementing this process, the data quantity to be transmitted between the entry point on the one hand and central data processor on the other can be reduced significantly, since there is absolutely no multiple transmission of the same document.

Even in the event of malfunctions or an offline operation of the communications link between the central data processor and individual entry points, implementing the method according to the invention as alternatively configured is advantageous, since known users can be given continued access.

If a user in such a situation with an unknown user identification for which no local virtual ticket exists desires access, an alternative configuration of the invention allows the system to consider whether a user should be given access or not. For example, it can be provided in this conjunction that access will be granted given the presence of user identification that is personalized and allows downstream invoicing, as is the case, for example, for credit cards, debit cards, personal ID cards, smart cards with stored user data and the like. This makes it possible to provide access even without an available virtual ticket, since the locally acquired data can be relayed to the central data processor for further processing after the malfunction or offline operation have been cleared up. By contrast, other forms of user identification that do not furnish any information about a user are rejected in the event of a malfunction and/or during offline operation.

The alternative method further makes it possible to recognize allowed and disallowed user identifications in the local database, meaning the storage unit provided for an entry point, via black and white lists. In addition, a statistical analysis can be easily performed.

The separate memory according to the invention is used to store the access code to be allocated to the virtual ticket, as already explained above. The separate memory can advantageously be a memory already present at the user of the ticketing system according to the invention, wherein “separate memory” in terms of the invention also includes those memories that are suitable as always to permanently accommodate and/or relay the access code. From this standpoint, a “separate memory” is also to be understood as including credit cards, identification cards, such as personal ID cards and/or the like. Such ID and/or payment cards have a one-to-one identification code, for example in the form of a personal ID code in the case of a personal ID. This code can be used as an access code within the confines of the invention, so that the ID bearing this code is to be regarded as a “separate memory” in terms of the invention. The advantage to using such a separate memory is that personal ID's already in possession of the user of the ticketing system can be integrated into the ticketing system, so that the system no longer has to provide additional memory and/or access codes. In this regard, the ticketing system according to the invention can have recourse to an existing infrastructure.

### BRIEF DESCRIPTION OF THE DRAWINGS

Additional features and advantages of the invention may be gleaned from the following description based on the figures. Shown on:

FIG. 1 is a diagrammatic view of the method according to the invention, and

FIG. 2 is a diagrammatic view of the method according to the invention in an alternative configuration.

### DESCRIPTION OF PREFERRED EMBODIMENTS

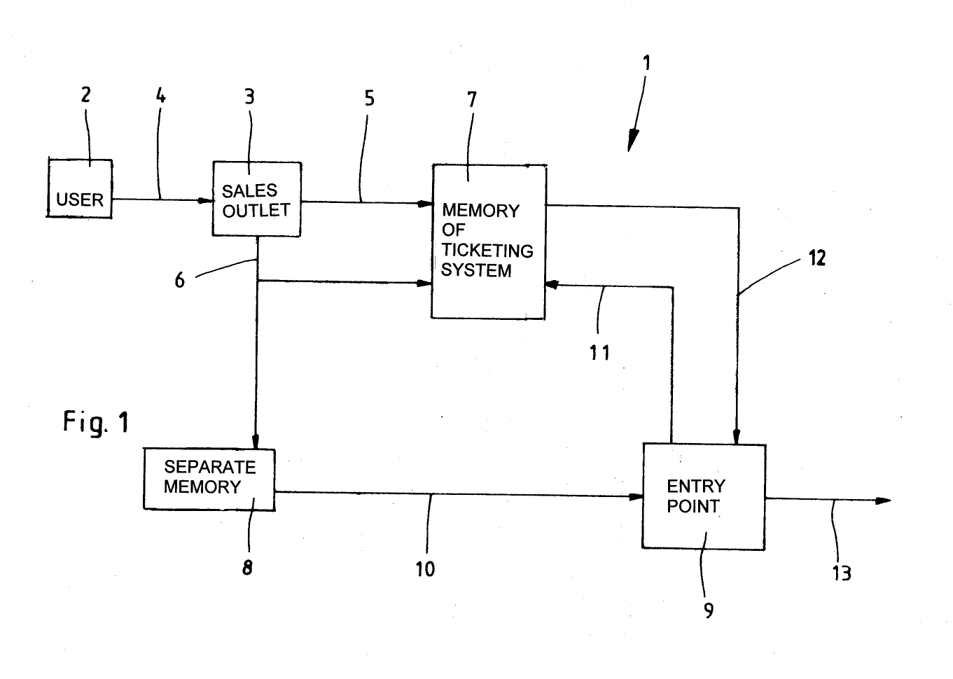

FIG. 1 shows a diagrammatic view of the method according to the invention for operating a ticketing system 1. A user 2 acquires an electronic ticket (virtual ticket) at a sales outlet 3. The purchase request is symbolized by arrow 4 in the depiction according to FIG. 1.

The electronic ticket 5 is stored in a central memory 7 of the ticketing system 1, the so-called back office.

The generation of the virtual ticket 5 is accompanied by the creation of an access code 6, which is person-independent. This access code 6 is also stored in the memory 7 of the ticketing system 1, wherein the access code 6 enables a one-to-one identification of the virtual ticket 5 allocated to the access code 6.

The access code 6 is further stored in a separate memory 8 to be carried by the user 2. If the virtual ticket 5 is now activated, meaning that the virtual ticket 5 is to be accessed by the user, an input 10 of the access code 6 must take place at the respective entry point 9 of the ticketing system 1, for example a validation and/or control point. If the separate data memory 8 is an electronic memory, the input 10 can also be electronically automated. In the easiest conceivable case, the data memory 8 can also be paper imprinted with the numerical code. In this case, input 10 can take place manually by way of a keyboard at the entry point (validation and/or control point) 9.

After the access code 6 has been entered, the validation and/or control point (entry point 9) relays the access code 6 to the memory 7 of the ticketing system 1. The process of relaying the access code 6 to the memory 7 is symbolized by reference number 11 in the depiction according to FIG. 1.

The access code 6 relayed to the memory 7 of the ticketing system 1 is used for the one-to-one identification of the accompanying virtual ticket 5, which is subsequently transmitted to the entry point (validation or control point) 9 as denoted by arrow 12. The virtual ticket 5 present in the form of a data record then triggers an output signal 13 at the entry point (validation or control point) 9, for example, to authorize access and/or the like.

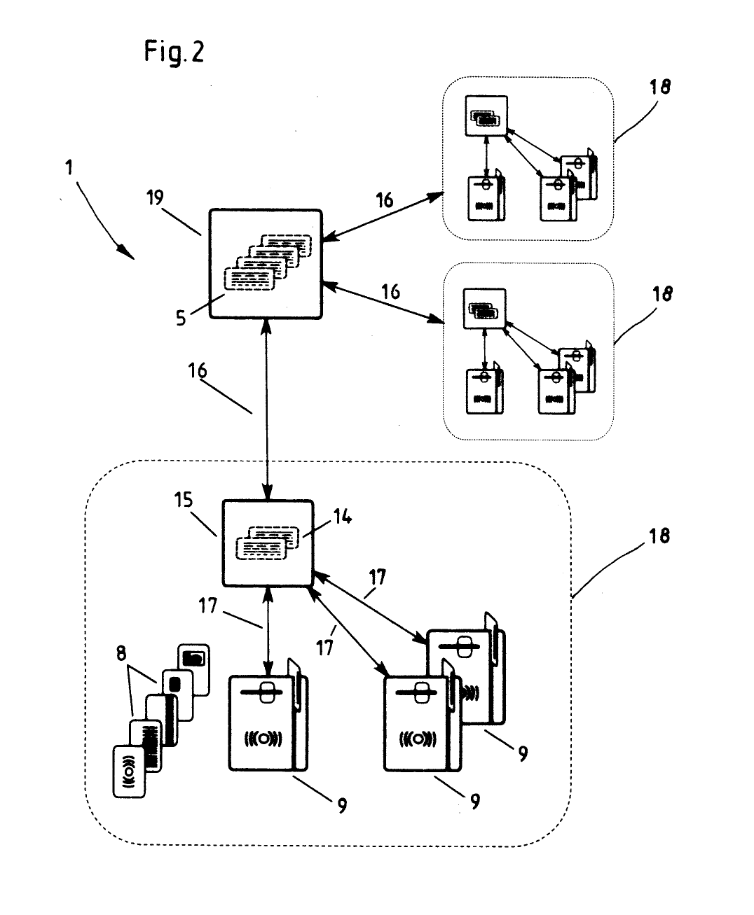

FIG. 2 shows a diagrammatic view of an alternative configuration of the ticketing system according to the invention. As opposed to FIG. 1 described above, the alternative embodiment according to FIG. 2 involves making a ticket copy 14 of the virtual ticket 5 centrally stored in the data processor 19, and then transmitting the copy 14 to a memory (not shown in any greater detail) of an entry point 9 by way of a communications link 16 and storing it there. FIG. 2 here shows an embodiment in which several entry points 9 belonging to a so-called local zone 18 are connected by a respective communications link 17 to a data processing unit 15, which has the data memory for storing a ticket copy 14 for all entry points 9 of a local zone 18.

As evident from the diagrammatic view on FIG. 2, a plurality of entry points 9 can be provided per local zone 18, wherein a plurality of local zones 18 can be created, with each respective local zone 18 being connected to the central data processor 19 via a communications link 16.

The method according to the invention as depicted on FIG. 2 works as follows:

The owner of a virtual ticket 5, the original of which is centrally stored in the central data processor 19, wants to use it for the first time. The access code 6 is stored in a prescribed manner in a separate memory 8, for example in the form of a data record stored on a credit card. FIG. 2 provides a diagrammatic view of possible memories 8.

The owner of the virtual ticket 5 activates it via an entry point 9, which is connected to the central data processor 19 via a communications link, with a local data processing unit 15 disposed between the two for communications purposes. When the virtual ticket 5 is accessed for the first time, the local data processing unit 15 generates a corresponding data record, and sends it to the central data processor 19. In response, the central data processor 19 creates a copy 14 of the virtual ticket 5. This ticket copy 14, meaning the accompanying data record, is relayed to the local data processing unit 15 and stored there. The data record is then processed here (15), meaning that the copy 14 of the virtual ticket 5 is processed. If valid, the user of the virtual ticket 5 can then be given the corresponding admission.

When the same virtual ticket 5 is used again, processing is exclusively local, taking place based on the ticket copy 14 generated when the ticket 5 was first used. No data transfer to the central data processor 19 takes place, and neither is data transported from the central data processor 19 to the accompanying entry point 9.

In terms of the method, it can be provided that the ticket copy 14 is kept in the data memory for a predeterminable time, after which it is automatically deleted. Until such time as the ticket copy 14 is deleted, when the virtual ticket 5 is accessed, the ticket 5 is exclusively processed based on the copy created beforehand.

The specification incorporates by reference the entire disclosure of European priority document 09 014 273.8 having a filing date of 16 Nov. 2009 and European priority document 10 000 711.1 having a filing date of 25 Jan. 2010.

While specific embodiments of the invention have been shown and described in detail to illustrate the inventive principles, it will be understood that the invention may be embodied otherwise without departing from such principles.

### REFERENCE LIST

1 Ticketing system
2 User
3 Sales outlet
4 Request
5 Virtual ticket
6 Access code
7 Memory of ticketing system
8 Separate memory
9 Entry point (validation and/or control point)
10 Input
11 Relay
12 Transmission
13 Output signal
14 Ticket copy
15 Data processing unit
16 Communications link
17 Communications link
18 Local zone
19 Central data processor

What is claimed is:

1. A method for operating a ticketing system, the method comprising:
generating a virtual ticket,
allocating an access code to the virtual ticket, which access code is independent of a user of the virtual ticket,
storing the virtual ticket together with the access code, wherein the access code is stored in a separate data memory,
accessing the virtual ticket by entering the access code stored in the separate data memory at an entry point of a ticketing system provided for entering the access code.

2. The method according to claim 1, wherein the access code is allocated to the virtual ticket during the step of generating the virtual ticket.

3. The method according to claim 1, wherein the virtual ticket is centrally stored together with the access code.

4. The method according to claim 1, comprising the step of activating the virtual ticket when the virtual ticket is used by the user for the first time.

5. The method according to claim 1, comprising the step of utilizing a data memory already in the possession of the user as the separate data memory.

6. The method according to claim 1, comprising the step of selecting a reusable data memory as the separate data memory.

7. The method according to claim 1, wherein the access code is provided by the user.

8. The method according to claim 1, comprising the steps of generating a copy of the virtual ticket when the virtual ticket is accessed for the first time and storing the copy in a data memory of the entry point where the virtual ticket is accessed for the first time.

9. The method according to claim 8, wherein the copy is stored for a predeterminable time in the data memory of the entry point.

10. The method according to claim 8, wherein several of said copy are generated and stored in the data memory of several predeterminable entry points, respectively.

11. The method according to claim 8, comprising the step of automatically deleting the virtual ticket and any copy of the virtual ticket after the virtual ticket has expired.

12. The method according to claim 1, comprising the step of automatically deleting the virtual ticket after the virtual ticket has expired.

13. The method according to claim 1, comprising the step of sending the access code to a central data processor upon presentation of the separate data memory at the entry point.

14. The method according to claim 13, comprising the step of sending data of the virtual ticket to the entry point for processing.

15. The method according to claim 14, wherein processing of the data of the virtual ticket involves determining a rate.

16. The method according to claim 15, wherein the rate is determined in the central data processor.

17. The method according to claim 14, wherein the data sent to the entry point are stored in a data memory of the entry point and sent to the central data processor for storage.

18. The method according to claim 14, wherein the data sent to the entry point are stored in a data memory of the entry point or sent to the central data processor for storage.
